(19) United States
(12) Patent Application Publication
(10) Pub. No.: US 2007/0176035 A1
(43) Pub. Date: Aug. 2, 2007

(54) Rotary motion control device

(76) Inventor: John P. Campbell, Hershey, PA (US)

Correspondence Address: Michael M. Zadrozny;SHLESINGER, ARKWRIGHT & GARVEY LLP, Suite 600, 1420 King Street, Alexandria, VA, 22314, US

(21) Appl. No.: 11/341,709

(22) Filed: Jan. 30, 2006

(51) Int. Cl. A01K 89/02; A01K 89/015; F16F 9/53; F16D 67/00

(52) U.S. Cl. 242/288; 192/18 B; 188/267.2

(57) ABSTRACT

This invention is a rotary motion control device comprising a housing, a rotor for connection to a rotary member to be braked, a magnetorheological material contacting the rotor, a first set of magnets having alternating magnetic orientation and a second set of magnets having alternating magnetic orientation, the first and second sets of magnets are adapted for selective alignment with respect to each other so that the magnetic orientation of one of the magnet sets may be repositioned relative to the other of the magnet sets to modulate the overall field strength of the magnets and change the viscosity of the magnetorheological material so that the shearing force on the rotor is increased or decreased. The invention further includes a fishing reel with a brake and a method for controlling the speed of a rotating member.

### FIELD OF THE INVENTION

This invention relates to rotary motion control devices such as brakes, clutches and related couplings and in particular, a rotary motion control device having a magnetorheological material.

### BACKGROUND OF THE INVENTION

Magnetic couplings in the form of brakes and clutches are known. In one prior art magnetic brake, the rotor is fitted with a hysteresis material and a yoke operatively associated with the rotor is provided with a permanent magnet so that relative rotation of the permanent magnet and the hysteresis material will result in a braking load.

The above brake is not satisfactory because the loading force is dependent upon the magnetic field generated in the gap extending between the magnet and the hysteresis material and adjustment of the gap to control the braking is difficult. In addition, hysteresis materials are expensive and their inclusion within a brake will unduly increase the overall cost of the brake.

It is also known to use a magnetorheological fluid within a brake, clutch or damper. Magnetorheological fluids are suspensions of micron-sized, magnetizable particles dispersed within a carrier fluid. The fluid is free-flowing under normal conditions but when subjected to a magnetic field its viscosity is caused to increase and a decelerating torque is applied to a rotating or reciprocating element. Prior art brakes and clutches having magnetorheological fluids require the use of an electromagnetic coil and associated power source to generate the magnetic field. In addition, the prior art devices require complex seals to prevent leakage of the magnetorheological fluid from the device. Accordingly, these devices are expensive to manufacture and have limited application due to their complexity and tendency to leak.

### BRIEF SUMMARY OF THE INVENTION

The invention is a rotary motion control device comprising a housing, a rotor, the rotor is adapted for connection to a rotary member to be braked, a magnetorheological material, the magnetorheological material is in contact with the rotor, a first set of magnets having alternating magnetic orientation and a second set of magnets having alternating magnetic orientation, the first and second sets of magnets are adapted for selective alignment with respect to each other so that the magnetic orientation of one of the first and second magnet sets may be repositioned relative to the other of the first and second magnet sets to modulate the overall field strength of the magnetic sets and cause a change in the viscosity of the magnetorheological material whereby the shearing force on said rotor is increased or decreased.

Another embodiment of the invention is a fishing reel comprising a reel housing, a spool rotatably supported within said housing, a brake, the brake comprising a rotor connected to the spool and rotatable therewith, a magnetorheological material, the magnetorheological material is in contact with the rotor, a first set of magnets having alternating magnetic orientation, a second set of magnets having alternating magnetic orientation, the first and second sets of magnets are adapted for selective alignment with respect to each other so that the magnetic orientation of one of said first and second magnet sets may be repositioned relative to the other of the first and second magnet sets to modulate the overall field strength of the magnetic sets and cause a change in the viscosity of the magnetorheological material whereby the shearing force on the rotor is increased or decreased and the spool is selectively braked.

Another embodiment of the invention is a method for controlling the rotary motion of a rotating member, the method comprising the steps of immersing the rotary member in a magnetorheological material, providing a plurality of permanent magnets, subjecting the magnetorheological material to a magnetic field generated by the magnets and varying the position of the magnets relative to each other to modify the magnetic field strength in the magnetorheological material thereby changing the viscosity of the magnetorheological material to increase or decrease the drag of the magnetorheological material on the rotating member.

### BRIEF DESCRIPTION OF THE SEVERAL VIEWS OF THE DRAWINGS

FIG. 1 is front perspective view of a brake according the present invention and showing a shaft in phantom lines;

FIG. 2 is a rear elevational view of the brake in FIG. 1 with the rotor, top plate, index disk and magnets shown in phantom lines;

FIG. 3 is front exploded perspective view of the device shown in FIG. 1;

FIG. 4 is a rear exploded perspective view of the device shown in FIG. 1;

FIG. 5 is a sectional view taken along line 5-5 of FIG. 2;

FIG. 6 is an enlarged detail sectional view of a portion of FIG. 5;

FIG. 7 is a schematic view showing the magnets fully opposed and the brake in the off setting;

FIG. 8 is a schematic view showing the magnets partially opposed and the brake in a low setting;

FIG. 9 is a schematic view showing the magnets partially supporting and the brake in a medium setting;

FIG. 10 is a schematic view showing the magnets fully supporting and the brake in the full on setting;

FIG. 11 is a front perspective view of a fishing reel in combination with a brake according to the present invention;

FIG. 12 is a side elevation, partially in section and taken along line 12-12 of FIG. 11;

FIG. 13 is a rear exploded perspective view of the fishing reel shown in FIG. 11; and

FIG. 14 a front exploded perspective view of the fishing reel shown in FIG. 12.

### DETAILED DESCRIPTION OF THE INVENTION

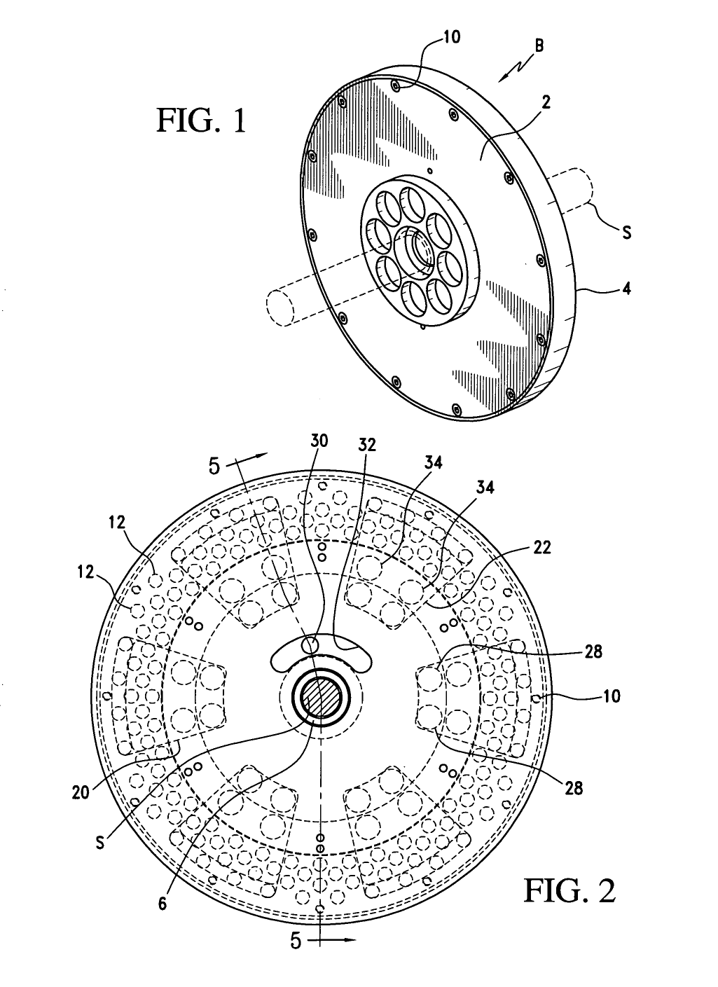

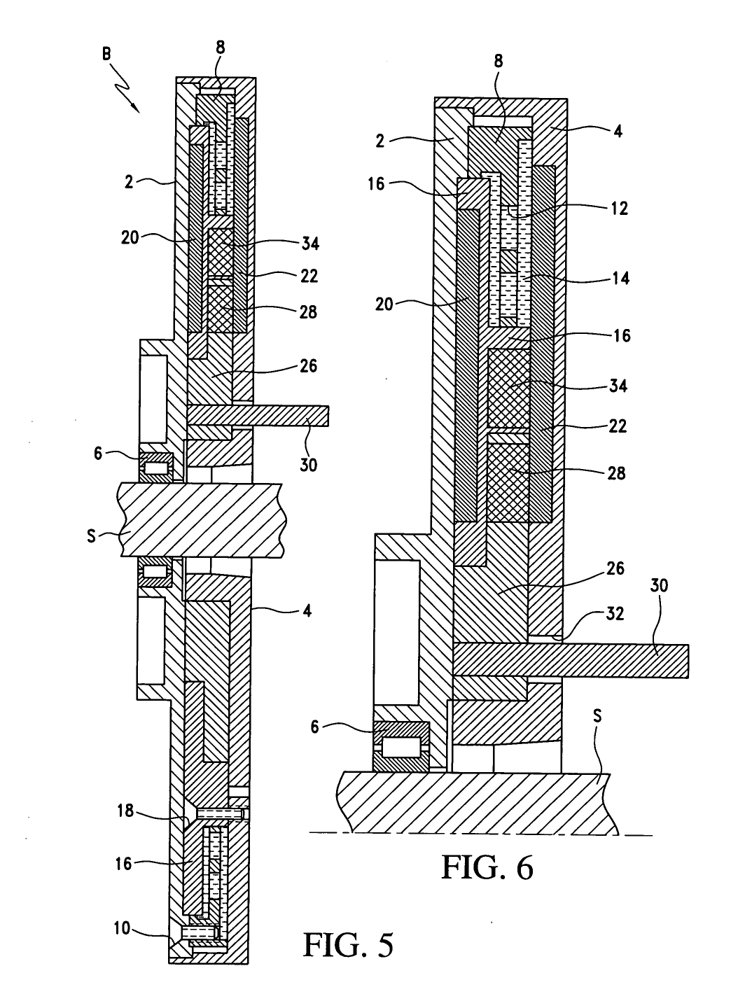

The brake or loading device according to a first embodiment of the invention is shown in FIGS. 1-6. The brake device B is shown provided with a housing or jacket formed from a rotating drive spool or plate 2 and a cup member 4 that is fixed relative to the drive plate 2. FIGS. 1 and 5 show the brake B supported on a shaft S via bearings 6.

Rotating drive spool 2 is fixed to a brake rotor 8 so that the rotor is movable with the drive spool 2. A series of connectors 10, shown in the drawings as rivets or screws, secure or otherwise connect the rotor 8 to the rotating drive spool 2. As is apparent, the drive spool 2 is adapted for rotation about its axis and is connected to a prime mover (not shown) to be braked. Rotor 8 is provided with a series of apertures or passageways 12 that extend through each side of the rotor.

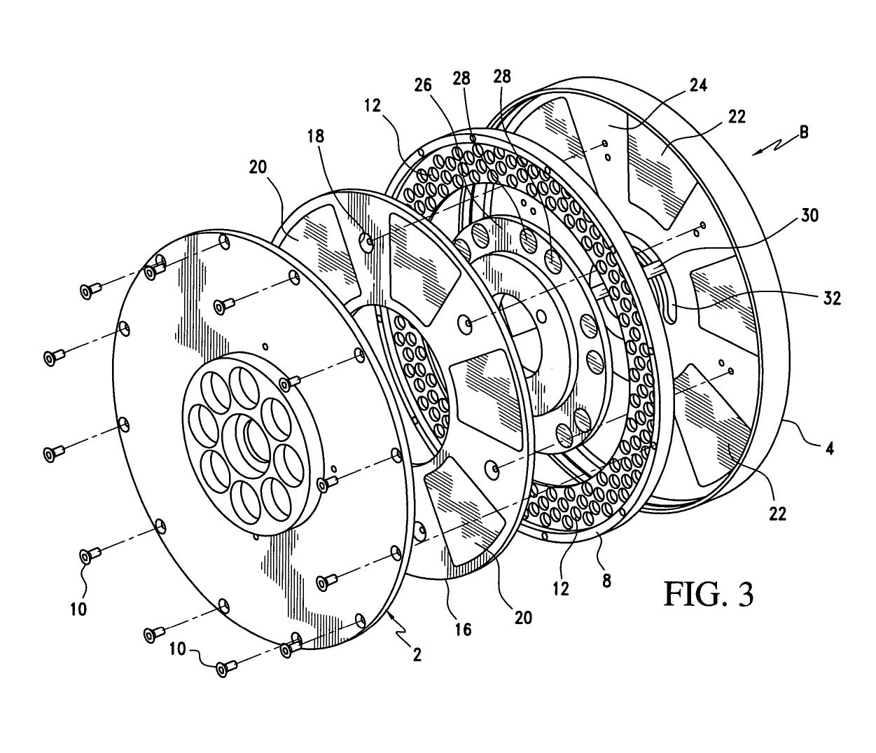

A top plate 16, disposed between the drive spool 2 and rotor 8 is secured to cup 4 by screws or rivet-like connectors 18. As best shown in FIG. 3, the position of the connecting screws 18 will not impede or interfere with movement of rotor 8. A first set of steel plates 20 are secured to the top plate 16 and individually spaced apart from each other in a circumferential manner as shown in the drawings. A second set of steel plate 22 are secured to the interior 24 of cup 4 and the second set of steel plates are also spaced apart from each other in a circumferential manner. The first set of steel plates 22 and the second set of steel plates are coplanar and aligned along common axes.

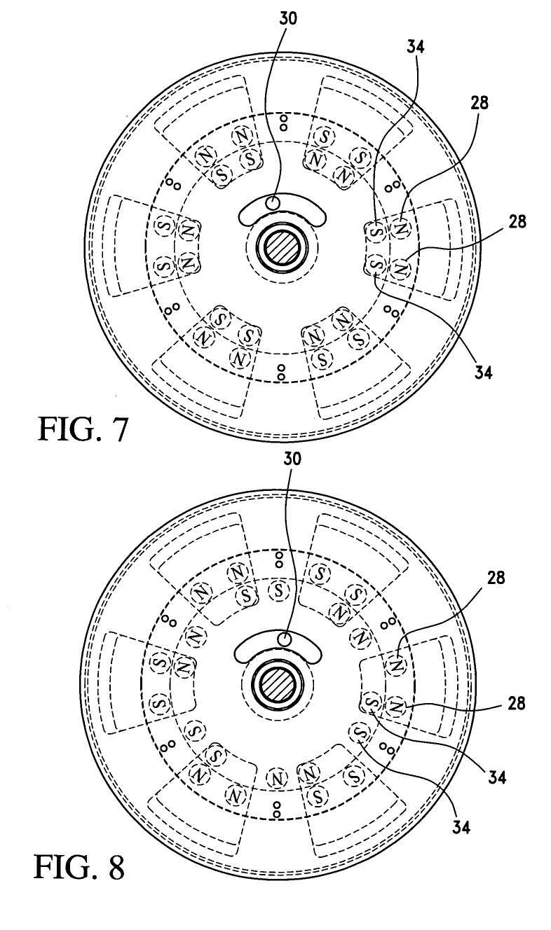

A rotating disk 26 is disposed between cup 4 and top plate 16. The disk 26 is provided with a dowel pin or control pin 30 that extends though slot 32 in cup 4. The dowel pin 30 enables the disk 26 to be selectively rotated about its central axis relative to the remaining components of the brake. Disk 26 is shown to contain multiple disk shaped permanent magnets 28 arranged in alternating pairs of magnetic orientation and that are spaced apart along the perimeter of disk 26 in a generally circumferential manner. In other words, each of the magnets forming a pair has the same magnetic orientation e.g. (NN) or (SS) and each pair of magnets has an magnetic orientation that is different than that of the next adjacent magnet pair as illustrated in FIGS. 7-10. As is apparent, it is within the scope of this invention to provide fewer pairs or a greater number of pairs of magnets than that shown in the drawings depending upon the particular application. It is also within the scope of the invention to not provide pairs but rather, alternating individual magnets.

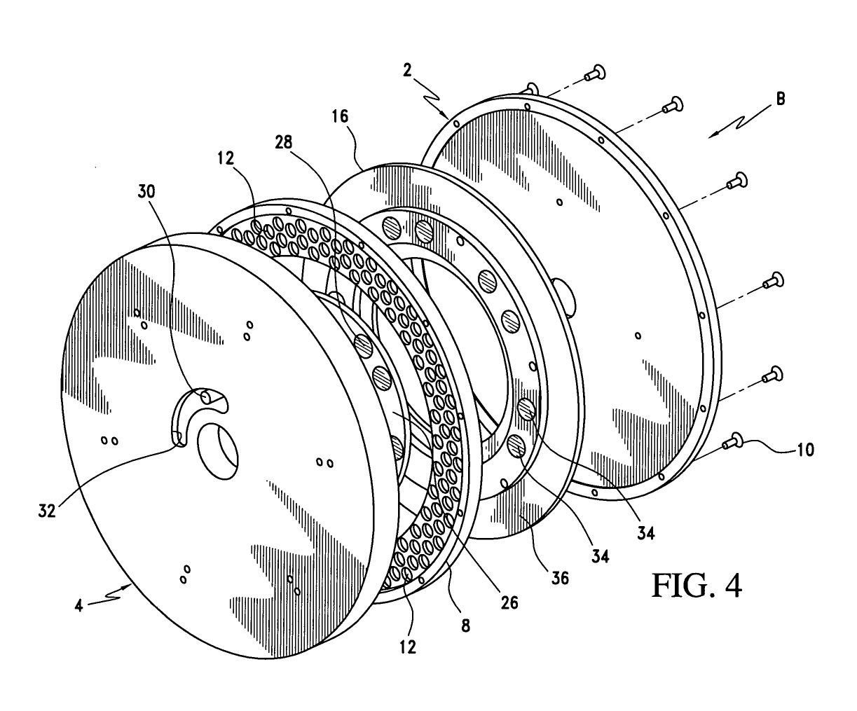

As best seen in FIG. 4, the face 36 of the top plate 16 that is adjacent disk 26 is provided contains a second set of disk shaped permanent magnets 34 arranged in alternating pairs of magnetic orientation and that are spaced apart around the perimeter of the face 36 of top plate 16 in a generally circumferential manner. Each of the magnets forming a pair has the same magnetic orientation e.g. (NN) or (SS) and each pair of magnets has a magnetic orientation that is different than that of the next adjacent magnet pair as illustrated in FIGS. 7-10. As is apparent, it is within the scope of this invention to provide fewer pairs or a greater number of pairs of magnets than that shown depending upon the particular application. It is also within the scope of the invention to not provide pairs but rather, alternating individual magnets.

Turning to FIG. 6, disk 26 is received within or otherwise fitted against stationary top plate 16 such that rotation of the disk about its axis will shift the alignment of the permanent magnet pairs 28 relative to the fixed permanent magnet pairs 34 on top plate 16 and relative to the associated pair of steel plates 20 and 22. As is apparent, it is within the scope of the invention to have the separate discs containing the separate sets of magnets to rotate relative to each other. The indexing or movable permanent magnets 28 and the stationary or fixed permanent magnets 34 lie in a common plane and the radius from the central axis for the indexing magnets is less than that for the fixed permanent magnets.

In one embodiment, the permanent magnets are commercially available Neodymium Iron Boron (NdFeB) rare earth permanent magnets that are sintered and nickel plated. Such magnets are commercially known as Grade 35 which is based upon the MMPA Standard 0100-00 magnets and describes the energy product of the magnet. It is of course within the scope of the present invention to use other magnets or differently shaped magnets depending upon the requirements of the brake or rotary motion control device and its end use.

FIG. 6 shows rotor 8 is disposed against a perimeter edge of the (non-rotating) top plate 16 and also against an interior edge surface of cup 4 to provide an interior chamber or gap that receives a magnetorheological material 14 in the form of a fluid, semi-fluid or grease depending upon the nature of the application for the rotary motion control device. As will be further explained below, the magnetorheological fluid or grease is adapted to freely to channel around and through the rotor passageways 12 when the brake is in an off-state but will increase drag on the rotor when the brake is in an on-state.

Magnetorheological or magnetic field responsive materials are ferrous based materials having a rheology affected by exposure to a magnetic field. These materials may be formulated so that their off-state viscosity is adapted to proportionally increase in response to an increasing magnetic field applied to the material. As the field strength is reduced, the material gradually reduces in viscosity and returns to its initial off-state viscosity. These materials contain micron-sized, field polarizable particles held in suspension within any of a variety of carrier components such as hydrocarbon oils, silicone oils, silicone copolymers, mineral oils, synthetic hydrocarbons, polyesters or other materials. The suspension or colloidal dispersion of magnetizable particles will not settle out under the influence of gravity or magnetic field or centrifugal force.

Suitable magnetorheological materials within the scope of the present invention are widely available and include those manufactured by Lord Corporation of Cary, N.C., for example, RHEONETIC™ MRF-132AD fluid. As is apparent, other magnetorheological fluids or greases are within the scope of the present invention depending upon the nature of the application and the drag requirements of the rotary motion control device. The operating temperature, density, coefficient of thermal expansion and viscosity of the magnetorheological material may be formulated in accordance with the requirements of the brake, clutch or rotary motion control device.

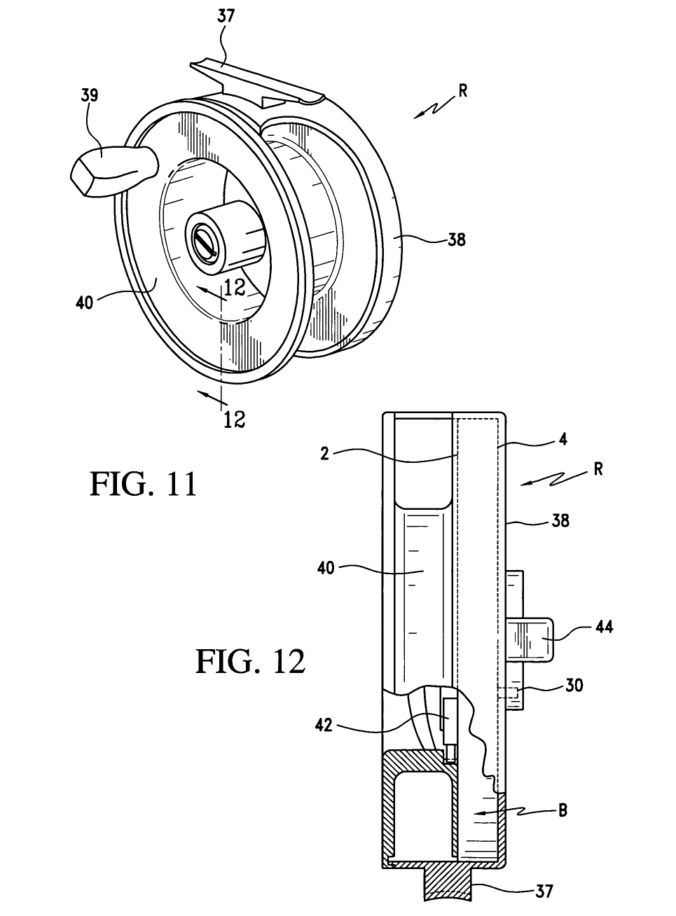

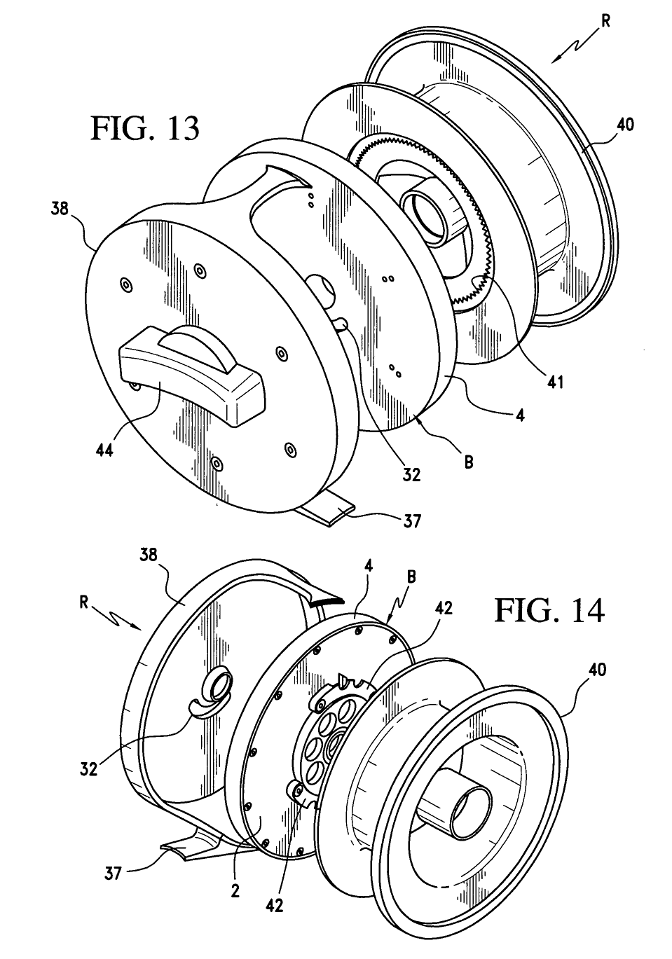

For example, RHEONETIC™ MRF-132AD fluid may be modified to increase its off-state viscosity by distilling, decanting or otherwise removing the hydrocarbon carrier oil component from the fluid and then replacing the distilled hydrocarbon carrier component with commercially available lithium grease in a ratio of three parts distilled magnetorheological fluid to two parts white lithium spray grease. The modified magnetorheological fluid was found to function effectively within the brake for a fishing reel brake as described below with respect to FIGS. 11-14 and reduced the need for extensive fluid seals within the brake.

Operation of the rotary control device illustrated in FIGS. 1-6 is as follows. Rotation of disk 26 will selectively shift the alignment of the magnets 28 relative to magnets 34 so that the magnetic orientation of one of the set of magnets is repositioned relative to the other set of magnets and modulation of the overall field strength of the magnets will occur. This is best illustrated in FIGS. 7-10. FIG. 7 depicts a setting of the brake in the full off position and the magnetic orientation of the movable permanent magnets 28 are fully opposed with the magnetic orientation of the fixed permanent magnets 34.

FIG. 8 shows the brake on a low setting where the movable disk 26 is rotated by dowel pin 30 and the magnetic orientation of permanent magnets 28 is repositioned relative to that of the fixed permanent magnets 34. A magnetic field having a given field strength is generated by this selective alignment and this generated field is directed by the steel plates 20 and 22 to the magnetorheological material. The magnetic field causes a change in rheology of the magnetorheological material 14 surrounding the rotor 8 resulting in a higher viscosity and shear of the material against the surface of the rotor 8 and a corresponding increase in drag and braking on the rotor.

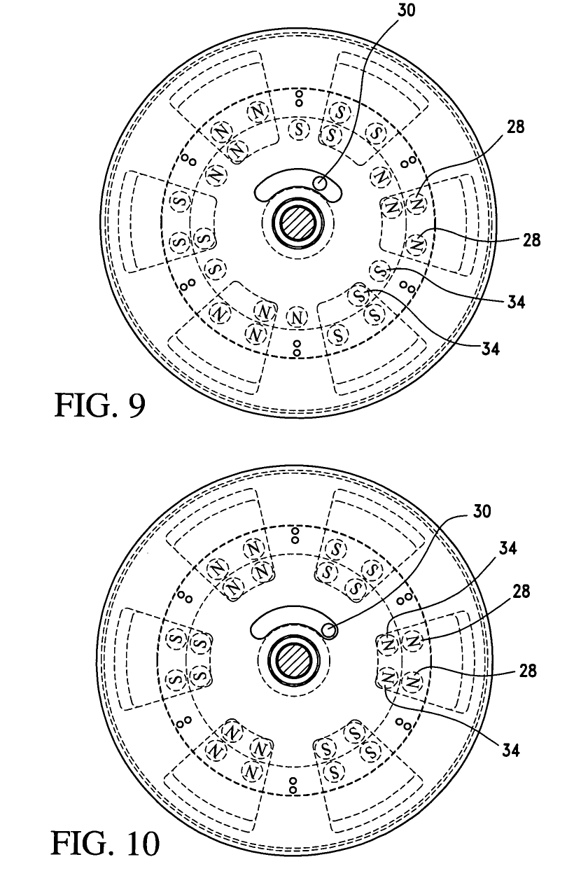

FIG. 9 shows the brake on a medium setting where the indexing disk is further rotated so that the magnetic orientation of the movable permanent magnets 28 is repositioned relative to the magnetic orientation of the fixed permanent magnets 34 and the field strength of the magnets is further modified. This causes a still greater increase in the magnetic field being generated across steel plates 20 and 22 and a proportionally higher change in rheology of the magnetorheological material 14 resulting in further shear on the rotor and a corresponding increase in drag and braking.

FIG. 10 shows the brake on the high setting where the movable disk 26 is rotated to its limit and the magnetic orientation of the permanent magnets 28 is realigned to fully support the magnetic orientation of the fixed permanent magnets 34 which maximizes the field strength of the magnets. The field produced from this full on position is directed by the steel plates to the magnetorheological material for maximum viscosity and drag on the rotor. The drag on the rotor generated by the device according to the present invention is uniform in application and consistent for each setting and provides braking that is smooth, quiet and without vibration.

It is within the scope of the invention to modify the various components of the above described rotary motion control device. The number, size and position of the permanent magnets relative to each other and the type of magnets selected and their shape or configuration may be optimized depending upon the end use of the rotary motion control device and the drag or braking requirements of the device. Such modifications equally apply to the pairs of steel plates and the shape and form of the rotor encased within the magnetorheological compound. Although commercially available magnets may be adequate for certain applications, it is within the scope of the invention to custom shape the magnets to provide a desired field strength and to increase the efficiency of the magnetorheological compound. The magnetorheological compound may be formulated or tailored to match the field strength generated by a certain magnet having a specific shape and therefore optimize the drag requirements of the compound to a particular application or use.

FIGS. 11-14 illustrate another embodiment of the invention. A fishing reel R is combined with a brake B as illustrated and described above. The fishing reel R comprises a reel frame or housing 38 having a foot 37 for securing the reel to a fly rod (not shown) in a known manner. A reel spool 40 for receiving and dispensing a length of line is operably attached to frame 38 and is mounted along the centerline of the reel and is provided with a handle 39 for rotating the reel spool 40.

Brake or drag B is disposed between the reel spool 40 and the reel frame 38. The brake cup 4 is shown fixedly mounted to the reel frame 38. A pair of ratcheting pawls 42 is mounted to the face of the drive spool 2. The pawls 42 engage an internal gear 41 disposed interior of the reel spool 40. The dowel pin 30 extends though slot 32 of cup 4 and is attached to a control knob 44 for adjusting the drag of the drag B. As is apparent, it is within the scope of the present invention to provide a gear driven adjustment in place of the dowel pin and slot embodiment.

Drag B operates in the manner as earlier described and will provide the reel with a smooth, quiet adjustable drag against rotation of spool 40. It is within the scope of this invention to adapt the drag B within a fishing reel other than the fly reel described in this embodiment.

Although this invention has been described above as having a preferred design, it is capable of further modifications, uses and adaptations that follow the general principles of the invention including departures from the above description that are known or a customary practice in the relevant art, provided the modifications and variations fall within the scope of the following claims or their equivalents.

What is claimed is:

1. A rotary motion control device comprising:
a) a housing;
b) a rotor, said rotor adapted for connection to a rotary member to be braked;
c) a magnetorheological material, said magnetorheological material is in contact with said rotor;
d) a first set of magnets having alternating magnetic orientation; and
e) a second set of magnets having alternating magnetic orientation, said first and second sets of magnets are adapted for selective alignment with respect to each other so that said magnetic orientation of one of said first and second magnet sets may be repositioned relative to the other of said first and second magnet sets to modulate the overall field strength of said magnetic sets and cause a change in the viscosity of said magnetorheological material whereby the shearing force on said rotor is increased or decreased.

2. A device as in claim 1 and wherein one of said first and second sets of magnets is stationary.

3. A device as in claim 1 and further comprising:
a) a first steel plate for directing the magnetic field of said first and second sets of magnets, said first steel plate is adjacent said first and second sets of magnets.

4. A device as in claim 3 and further comprising:
a) a second steel plate for directing the magnetic field of said first and second magnets, said first and second steel plates comprise a first pair of steel plates, said first and second sets of magnets are disposed between said first and second steel plates.

5. A device as in claim 1 and wherein said first and second sets of magnets are coplanar and extend radially from a common axis, the radius from the common axis for one of said first and second sets of magnets is less than that for the other of said first and second sets of magnets.

6. A device as in claim 4 and wherein said first set of magnets is mounted on a first disk and said second set of magnets is mounted on a second disk, said disks are concentric and said second disk is rotatable relative to said first disk.

7. A device as in claim 6 and wherein each of said first and second sets of magnets comprising equal numbers of multiple pairs of permanent magnets arranged on the respective one of said first and second disks in a spaced relation.

8. A device as in claim 6 and wherein said first and second disks are concentric to and coplanar with said rotor.

9. A device as in claim 1 and wherein said rotor having openings extending therethrough to allow said magnetorheological material to channel through said rotor.

10. A device as in claim 8 and wherein said housing comprises a cup member and a drive plate, said drive plate is connected to said rotor and rotatable therewith.

11. A device as in claim 10 and wherein said first steel plate is secured to said cup member and said second steel plate is secured to said first disk.

12. A device as in claim 1 and further including:
a) a control member, said control member is operatively associated with said second disk to selectively rotate the same.

13. A device as in claim 12 and wherein said control member is a dowel pin connected to said second disk and extending transverse therefrom.

14. A device as in claim 1 and wherein said magnetorheological material is at least one of a liquid, semi-liquid, or grease.

15. A device as in claim 1 and wherein said magnetorheological material having a lithium based grease as the carrier component.

16. A device as in claim 1 and wherein said first and second sets of magnets are in the form of separate permanent magnets in the shape of a disk.

17. A device as in claim 11 and further comprising:
a) additional pairs of steel plates where one of the steel plates comprising each of said additional pairs of steel plates is secured to said cup member and in a spaced relation from said first pair of steel plates and the other steel plate forming each of said additional pairs of steel plates is secured to said first disk and in a spaced relation from said first pair of steel plates.

18. A device as in claim 10 and wherein said drive plate is adapted to be connected to the rotating member to be braked.

19. A device as in claim 1 and wherein said first and second sets of magnets comprise rare earth magnets.

20. A device as in claim 19 and wherein said first and second sets of magnets are NdFeB magnets.

21. A fishing reel comprising:
a) a reel housing;
b) a spool, said spool rotatably supported within said housing; and
c) a brake, said brake rotor comprising a rotor connected to said spool and rotatable therewith, a magnetorheological material, said magnetorheological material is in contact with said rotor, a first set of magnets having alternating magnetic orientation, a second set of magnets having alternating magnetic orientation, said first and second sets of magnets are adapted for selective alignment with respect to each other so that said magnetic orientation of one of said first and second magnet sets may be repositioned relative to the other of said first and second magnet sets to modulate the overall field strength of said magnetic sets and cause a change in the viscosity of said magnetorheological material whereby the shearing force on said rotor is increased or decreased and said spool is selectively braked.

22. A fishing reel as in claim 21 and wherein one of said first and second sets of magnets is stationary.

23. A fishing reel as in claim 21 and further comprising:
a) a first steel plate for directing the magnetic field of said first and second sets of magnets, said first steel plate is adjacent said first and second sets of magnets.

24. A fishing reel as in claim 23 and further comprising:
a) a second steel plate for directing the magnetic field of said first and second magnets, said first and second steel plates comprise a first pair of steel plates, said first and second sets of magnets are disposed between said first and second steel plates.

25. A fishing reel as in claim 21 and wherein said first and second sets of magnets are coplanar and extend radially from a common axis, the radius from the common axis for one of said first and second sets of magnets is less than that for the other of said first and second sets of magnets.

26. A fishing reel as in claim 24 and wherein said first set of magnets is mounted on a first disk and said second set of magnets is mounted on a second disk, said disks are concentric and said second disk is rotatable relative to said first disk.

27. A fishing reel as in claim 26 and wherein each of said first and second sets of magnets comprising equal numbers of multiple pairs of permanent magnets that are arranged on the respective one of said first and second disks in a spaced relation.

28. A fishing reel as in claim 26 and wherein said first and second disks are concentric to and coplanar with said rotor.

29. A fishing reel as in claim 21 and wherein said rotor having openings extending therethrough to allow said magnetorheological material to channel through said rotor

30. A fishing reel as in claim 28 and further comprising:
a) a brake housing, said brake housing comprising a cup member fixed to said reel housing and a drive plate cooperating with said cup member, said drive plate is rotatably connected to said rotor and adapted for rotatable engagement with said reel spool.

31. A fishing reel as in claim 30 and wherein said first steel plate is secured to said cup member and said second steel plate is secured to said first disk.

32. A fishing reel as in claim 30 and further including:
a) a control member, said control member is operatively associated with said second disk to selectively rotate the same.

33. A fishing reel as in claim 32 and wherein said control member is a dowel pin connected to said second disk and extending transverse therefrom through each of said cup member and said reel housing.

34. A fishing reel as in claim 21 and wherein said magnetorheological material is at least one of a liquid, semi-liquid, or grease.

35. A fishing reel as in claim 21 and wherein the carrier in said magnetorheological material is a lithium based grease.

36. A fishing reel as in claim 21 and wherein said first and second sets of magnets are in the form of separate permanent magnets each of which is disc shaped.

37. A fishing reel as in claim 31 and further comprising:
a) additional pairs of steel plates where one of the steel plates forming each of said additional pairs of steel plates is secured to said cup member and in a spaced relation from said first pair of steel plates and the other of the steel plates forming each of said additional pairs of steel plates is secured to said first disk and in a spaced relation from said first pair of steel plates.

38. A fishing reel as in claim 30 and wherein said drive plate is adapted to be connected to said spool.

39. A fishing reel as in claim 21 and wherein said first and second sets of magnets comprise rare earth magnets.

40. A fishing reel as in claim 39 and wherein said first and second sets of magnets are NdFeB magnets.

41. A fishing reel as in claim 30 and further comprising:
a) a ratcheting pawl mechanism connected to said drive plate and gear teeth provided on said spool, said ratcheting pawl mechanism operatively associated with said gear teeth provide selective rotational engagement of said drive plate with said spool.

42. A method for controlling the rotary motion of a rotating member, comprising the steps of:
a) immersing the rotary member in a magnetorheological material;
b) providing a plurality of permanent magnets;
c) subjecting the magnetorheological material to a magnetic field generated by the magnets; and
d) varying the position of the magnets relative to each other to modify the magnetic field strength in the magnetorheological material thereby changing the viscosity of the magnetorheological material to increase or decrease the drag of the magnetorheological material on the rotating member.

43. A method as in claim 42 and comprising the additional steps of:
a) providing first and second magnetic plates on either side of the rotating member;
b) positioning the magnets at one end of the plates and the rotating member at the other end of the plates; and
c) orientating the polarity of the magnets such that the magnetic field strength at the other end of the plates is increased to thereby increase the magnetic field strength entering the magnetorheological material whereby the viscosity of the magnetorheological material is caused to be increased.

44. A method as in claim 42 and comprising the additional steps of:
a) providing first and second magnetic plates on either side of the rotating member;
b) positioning the magnets at one end of the plates and the rotating member at the other end of the plates; and
c) orientating the polarity of the magnets relative to each other such that the magnetic field strength at the other end of the plates is decreased thereby to decrease the magnetic field strength directed against the magnetorheological material, whereby the viscosity of material is caused to be decreased.
